(19) United States
(12) Patent Application Publication
(10) Pub. No.: US 2014/0211021 A1
(43) Pub. Date: Jul. 31, 2014

(54) TEST SYSTEM FOR EVALUATING MOBILE DEVICE AND DRIVING METHOD THEREOF

(71) Applicant: SAMSUNG ELECTRONICS CO., LTD., Suwon-si (KR)

(72) Inventor: SUNG-HWAN ROH, Seoul (KR)

(73) Assignee: SAMSUNG ELECTRONICS CO., LTD., Suwon-si (KR)

(21) Appl. No.: 14/157,041

(22) Filed: Jan. 16, 2014

(30) Foreign Application Priority Data
Jan. 25, 2013 (KR) 10-2013-0008824

(51) Int. Cl. G06K 9/68; H04N 17/00

(52) U.S. Cl. CPC G06K 9/68; H04N 17/002
USPC 348/187; 382/218

(57) ABSTRACT

A test system includes a mobile device including an evaluation application, and a host including a test automation framework (TAF). The host is configured to receive an image corresponding to a screen of the mobile device via the evaluation application and the TAF, display the received image on a screen of the host, scan the received image, and identify a portion of the received image based on a result of scanning the received image.

### CROSS-REFERENCE TO RELATED APPLICATIONS

This application claims priority under 35 U.S.C. §119 to Korean Patent Application No. 10-2013-0008824, filed on Jan. 25, 2013, the disclosure of which is hereby incorporated by reference in its entirety.

### TECHNICAL FIELD

Exemplary embodiments of the present inventive concept relate to a test system, and more particularly, to a test system for evaluating a mobile device, and a driving method thereof.

### DISCUSSION OF THE RELATED ART

As a result of the development and prevalence of mobile devices and the convergence of multimedia functions, the complexity of software on mobile devices is increasing. Accordingly, requirements for tools for evaluating mobile devices and test automation are increasing. As the complexity of mobile devices increases, test times also increase. As test times increase, fatigue of quality assurance (QA) engineers caused by long tests may decrease the efficiency of problem detection.

### SUMMARY

Exemplary embodiments of the present inventive concept provide a test system for automatically evaluating a mobile device, and a driving method of the test system.

According to an exemplary embodiment of the present inventive concept, a test system includes a mobile device and a host for evaluating the mobile device. The host receives an image corresponding to the screen of the mobile device from the mobile device, displays the received image on the screen of the host, scans the screen of the host, and recognizes the image based on the results of the scanning.

In an exemplary embodiment, the host may send an event to the mobile device.

In an exemplary embodiment, the image may include a plurality of icons or a plurality of widgets.

In an exemplary embodiment, the host may compare a bitmap corresponding to the screen of the host to bitmaps respectively corresponding to the plurality of icons stored in the host, or to bitmaps respectively corresponding to the plurality of widgets stored in the host.

In an exemplary embodiment, the host may recognize the screen of the host based on the results of the comparison.

In an exemplary embodiment, the mobile device may be connected to the host through an android debug bridge (ADB), and the ADB may utilize a Universal Serial Bus On-The-Go (USB OTG) specification.

In an exemplary embodiment, the host may store a test automation framework (TAF) for evaluating the mobile device, and the TAF may include a virtual screen module (VSM) configured to receive the image corresponding to the screen of the mobile device from the mobile device, and to display the received image on the screen of the host. The TAF may further include a screen scanning module (SSM) configured to scan the screen of the host, and a framework core module (FCM) configured to recognize the screen of the host based on the results of the scanning. The FCM may include a basic test module for evaluating the mobile device, and the basic test module may load a test case for evaluating hardware or the software of the mobile device, and drive the test case.

In an exemplary embodiment, the TAF may further include a user-developed test module using the basic test module.

In an exemplary embodiment, the TAF may further include a picture test module (PTM) configured to evaluate operation of displaying pictures using the basic test module, a camera test module (CTM) configured to evaluate the operation of a camera using the basic test module, and a power measurement module (PMM) configured to measure power consumption using the basic test module.

In an exemplary embodiment, the mobile device may be driven by the Android™ Operating System (OS), and the mobile device may be a smartphone, a tablet PC, or a digital camera.

In accordance with an exemplary embodiment of the present inventive concept, a driving method of a test system including a host for evaluating a mobile device includes displaying an image corresponding to the screen of the mobile device on the screen of the host, scanning the screen of the host, and recognizing the image based on the results of the scanning.

In an exemplary embodiment, the driving method may further include sending an event to the mobile device if no event is generated in the mobile device.

In an exemplary embodiment, sending the event may include executing the event by the mobile device.

In an exemplary embodiment, scanning the screen of the mobile device may include comparing the bitmap corresponding to the image to bitmaps respectively corresponding to a plurality of icons stored in the host, or to bitmaps respectively corresponding to a plurality of widgets stored in the host.

In an exemplary embodiment, recognizing the image may include recognizing the locations of the plurality of icons or the plurality of widgets forming the image based on the results of the comparison.

According to an exemplary embodiment of the present inventive concept, a test system includes a mobile device including an evaluation application, and a host including a test automation framework (TAF). The host is configured to receive an image corresponding to a screen of the mobile device via the evaluation application and the TAF, display the received image on a screen of the host, scan the received image, and identify a portion of the received image based on a result of scanning the received image.

According to an exemplary embodiment of the present inventive concept, a driving method of a test system includes receiving an image corresponding to a screen of a mobile device at a host, displaying the received image on a screen of the host, scanning the received image displayed on the screen of the host, and identifying a portion of the received image based on a result of scanning the received image.

According to an exemplary embodiment of the present inventive concept, a test system includes a test automation framework (TAF) stored at a host. The TAF includes a virtual screen module (VSM) configured to receive an image corresponding to a screen of a mobile device from an evaluation application stored at the mobile device, and display the received image at the host, a screen scanning module (SSM) configured to scan the received image, and a framework core module (FCM) configured to identify a portion of the received image based on a result of scanning the received image.

The test system, according to exemplary embodiments, may automatically evaluate a mobile device.

Further, the driving method of the test system, according to exemplary embodiments, may provide a method for automatically evaluating a mobile device.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram showing a test system, according to an exemplary embodiment of the present inventive concept.

FIG. 2 is a block diagram showing a hierarchical structure of hardware and software of a mobile device shown in FIG. 1, according to an exemplary embodiment of the present inventive concept.

FIG. 3 is a block diagram showing an application of the mobile device shown in FIG. 2, according to an exemplary embodiment of the present inventive concept.

FIG. 4 shows examples of the mobile device shown in FIG. 1, according to exemplary embodiments of the present inventive concept.

FIG. 5 is a block diagram showing a test automation framework (TAF) shown in FIG. 1, according to an exemplary embodiment of the present inventive concept.

FIG. 6 shows a screen of a host shown in FIG. 1, according to an exemplary embodiment of the present inventive concept.

FIG. 7 is a flowchart showing a driving method of the test system shown in FIG. 1, according to an exemplary embodiment of the present inventive concept.

FIG. 8 illustrates a driving operation of the mobile device and the host shown in FIG. 1, according to an exemplary embodiment of the present inventive concept.

FIG. 9 shows an example of settings of the TAF shown in FIG. 5, according to an exemplary embodiment of the present inventive concept.

FIG. 10 is a block diagram showing a framework core module (FCM) shown in FIG. 5, according to an exemplary embodiment of the present inventive concept.

FIG. 11 is a block diagram showing a picture test module shown in FIG. 5, according to an exemplary embodiment of the present inventive concept.

FIGS. 12 through 20 show examples of the screens of the host shown in FIG. 1 and scripts for driving the TAF shown in FIG. 1, according to exemplary embodiments of the present inventive concept.

FIG. 21 shows an exemplary computer system for executing a method according to an exemplary embodiment of the present inventive concept.

### DETAILED DESCRIPTION OF THE EXEMPLARY EMBODIMENTS

Exemplary embodiments of the present inventive concept will be described more fully hereinafter with reference to the accompanying drawings. Like reference numerals may refer to like elements throughout the accompanying drawings.

It will be understood that when a component is referred to as being “connected to” or “coupled to” another component, it can be directly on, connected or coupled to the other component, or intervening components may be present.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

As used herein, the terms evaluating and testing with regards to a mobile device may be used interchangeably.

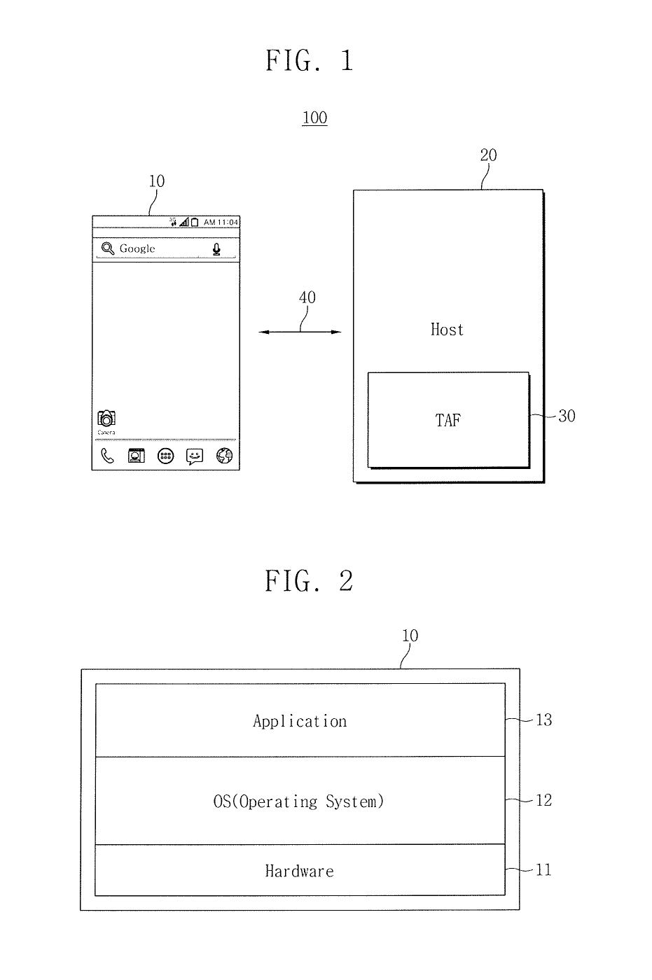

FIG. 1 is a block diagram showing a test system 100, according to an exemplary embodiment of the present inventive concept.

Referring to FIG. 1, the test system 100 includes a mobile device 10 and a host 20. The host 20 may be used to evaluate the mobile device 10.

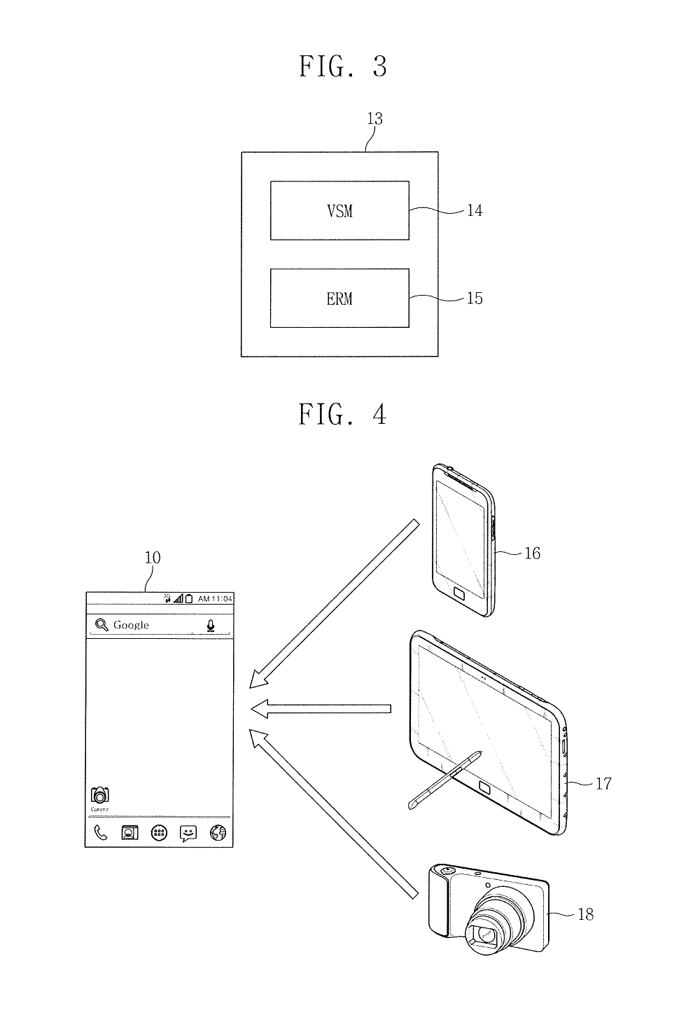

For example, when the hardware or software of the mobile device 10 changes, the hardware or software of the mobile device 10 may be evaluated. According to exemplary embodiments, the mobile device 10 may be, for example, a smartphone, a tablet PC, or a digital camera, however the mobile device 10 is not limited thereto. The mobile device 10 will be described in further detail with reference to FIGS. 2 and 3.

The host 20 is a test apparatus that may be used to evaluate the mobile device 10. The host 20 includes a test automation framework (TAF) 30. The TAF includes software that is used to evaluate the mobile device 10. According to exemplary embodiments, the host 20 may be, for example, a personal computer, a workstation, a server, a mainframe computer, or a supercomputer, however the host 20 is not limited thereto.

The TAF 30 receives an image corresponding to the screen of the mobile device 10, displays the received image on the screen of the host 20, scans the displayed screen, and identifies the content of the image based on the result of the scanning.

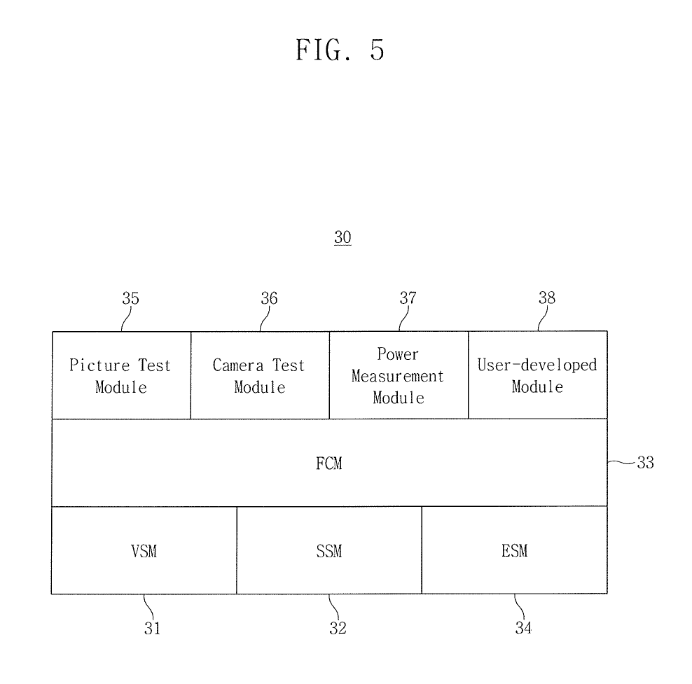

The TAF 30 may automatically send an event to the mobile device 10. The event may mimic an actual operation performed on the mobile device 10. For example, the event may include an operation corresponding to touching or dragging a specific application icon, an operation corresponding to typing on the screen of the mobile device 10, an operation corresponding to swiping between different screens of the mobile device 10, an operation corresponding to navigating through various menus of the mobile device 10, etc. The TAF 30 will be described in further detail with reference to FIG. 5.

In an exemplary embodiment, the test system 100 may include an android debug bridge (ADB) 40 for connecting the mobile device 10 to the host 20. The ADB 40 is used to physically connect the mobile device 10 to the host 20. According to an exemplary embodiment, the ADB 40 may utilize the Universal Serial Bus On-The-Go (USB OTG) specification. The ADB 40 may be utilized in the test system 100 to evaluate a mobile device 10 that uses the Android™ operation system. However, the mobile device 10 is not limited to a device running the Android™ operating system. As a result, protocols other than the ADB 40 may be included in the test system 100 to allow for the connection of other mobile devices 10 (e.g., mobile devices 10 running operating systems other than Android™) to the host 20 for evaluation. Further, the mobile device 10 may be connected to the host 20 using the Joint Test Action Group (JTAG) specification.

The TAF 30 may test the mobile device 10 to determine whether the mobile device 10 is capable of properly displaying images. For example, the TAF 30 may evaluate hundreds of pictures. While testing the mobile device 10, the TAF 30 may store a screenshot of each test stage.

The TAF 30 may execute a benchmark application on the mobile device 10, and read the resultant score. Further, while the benchmark application is driven, the TAF 30 may measure the amount of power consumption of the mobile device 10. The TAF 30 may be used for daily regression testing and an aging test.

The TAF 30 may iteratively execute the same task a specified number of times. Accordingly, a test engineer or worker can use the test system 100 to spend less time on a repetitive or iterative task.

FIG. 2 is a block diagram showing a hardware description layer (HAL) of the mobile device 10 shown in FIG. 1, according to an exemplary embodiment of the present inventive concept.

Referring to FIGS. 1 and 2, the mobile device 10 may include hardware 11 such as, for example, a display device, a touch panel, a camera, an application processor, etc. The mobile device 10 may be managed by an operating system (OS) 12 for driving the hardware 11. Further, the mobile device 10 may include an application 13 (e.g., an evaluation application) for controlling the hardware 11 on the OS 12, allowing the mobile device 10 to perform additional functions.

The OS 12 is system software that manages the hardware 11 and provides a common system service and a hardware description platform for executing the application 13. According to exemplary embodiments, the OS 12 may be, for example, Windows™ (including Windows Phone), iOS™, Android™, or TIZEN™, however the OS 12 is not limited thereto.

The TAF 30 may evaluate the respective interfaces between the hardware 11 and the OS 12, and between the OS 12 and the application 13.

FIG. 3 is a block diagram showing the application 13 of the mobile device 10 shown in FIG. 2, according to an exemplary embodiment of the present inventive concept.

Referring to FIGS. 1, 2, and 3, the application 13 on the mobile device 10 may include a virtual screen module (VSM) 14 and an event receiving module (ERM) 15. The VSM 14 and the ERM 15 function as software used to evaluate the mobile device 10. The VSM 14 may send an image corresponding to the screen of the mobile device 10 to the host 20, and the TAF 30 may display the screen of the mobile device 10 on the screen of the host 20.

If no event is generated at the mobile device 10, the TAF 30 may send an event to the mobile device 10, as described above. The ERM 15 may receive the event from the TAF 30, and execute the event on the mobile device 10.

FIG. 4 shows examples of the mobile device 10 shown in FIG. 1, according to exemplary embodiments of the present inventive concept.

Referring to FIG. 4, the mobile device 10 may be, for example, a smartphone 16, a tablet PC 17, or a digital camera 18.

FIG. 5 is a block diagram showing the TAF 30 shown in FIG. 1, according to an exemplary embodiment of the present inventive concept.

Referring to FIGS. 1, 3, and 5, the TAF 30 is software used to evaluate the mobile device 10. The TAF 30 may include a virtual screen module (VSM) 31, a screen scanning module (SSM) 32, a framework core module (FCM) 33, and an event sending module (ESM) 34.

The VSM 31 may receive an image corresponding to the screen of the mobile device 10 from the VSM 14 of the mobile device 10. The VSM 31 may display the received image on the screen of the host 20. That is, the VSM 31 may relay the screen image of the mobile device 10 to the screen of the host 20.

The screen image of the mobile device 10 may be, for example, a graphic user interface (GUI). For example, if the mobile device 10 uses the Android™ OS, the GUI may correspond to a home screen that includes icons or widgets corresponding to a plurality of applications capable of being executed by the Android™ OS.

The SSM 32 scans the screen image of the mobile device 10. For example, the SSM 32 may compare an image file (e.g., a bitmap) corresponding to the screen image of the mobile device 10 to other image files (e.g., other bitmaps) stored at the host 20 corresponding to the respective icons, or to other image files (e.g., bitmaps) stored at the host 20 corresponding to the respective widgets. The SSM 32 may send the results of the comparison to the FCM 33.

The FCM 33 may identify a portion of the screen image of the mobile device 10 based on the results of the comparison. For example, the FCM 33 may identify the respective locations of a plurality of icons or a plurality of widgets that form the screen (e.g., when the screen corresponds to a GUI) of the mobile device 10. Accordingly, the TAF 30 may evaluate any one of a plurality of icons or a plurality of widgets. Further, the FCM 33 may determine the event that will be generated on the screen of the mobile device 10 through the SSM 32. Although the present example describes a screen image of the mobile device 10 corresponding to the GUI of the mobile device 10, including icons and/or widgets present in the GUI, exemplary embodiments of the present inventive concept are not limited thereto. For example, exemplary embodiments may be used to perform evaluation of other areas of the mobile device 10 such as, for example, within different settings screens of the mobile device 10, within specific applications installed on the mobile device 10, etc.

Further, if the screen of the mobile device 10 does not need to be scanned, the FCM 33 may request the ESM 34 to send an event to the mobile device 10. Accordingly, the ERM 15 of the mobile device 10 may receive an event sent from the ESM 34 of the host 20, and in response, the ERM 15 may then provide an actual effect corresponding to the event to the screen of the mobile device 10.

The FCM 33 may determine the event that will be generated next on the mobile device 10. For example, the FCM 33 may send an event to the mobile device 10 corresponding to touching the screen of the mobile device 10, typing letters on the mobile device 10, etc. The FCM 33 is capable of determining the proper event to subsequently generate as a result of the FCM 33 having the capability to identify the current screen of the mobile device 10.

Accordingly, the TAF 30 can dynamically process the screens of the mobile device 10 without having to estimate a fixed delay between the changing of screens. That is, because the FCM 33 recognizes the content of the screen of the mobile device 10, the host 20 is able to interact with the mobile device 10 to perform evaluation of the mobile device 10 without the interaction of a user.

As described above, if no event is generated by the mobile device 10, the ESM 34 may send an event to the mobile device 10. For example, if the FCM 33 determines that an event corresponding to touching an arbitrary location on the screen of the mobile device 10 should be sent to the mobile device 10 for evaluation purposes, the FCM 33 may send the event to the mobile device 10 through the ESM 34.

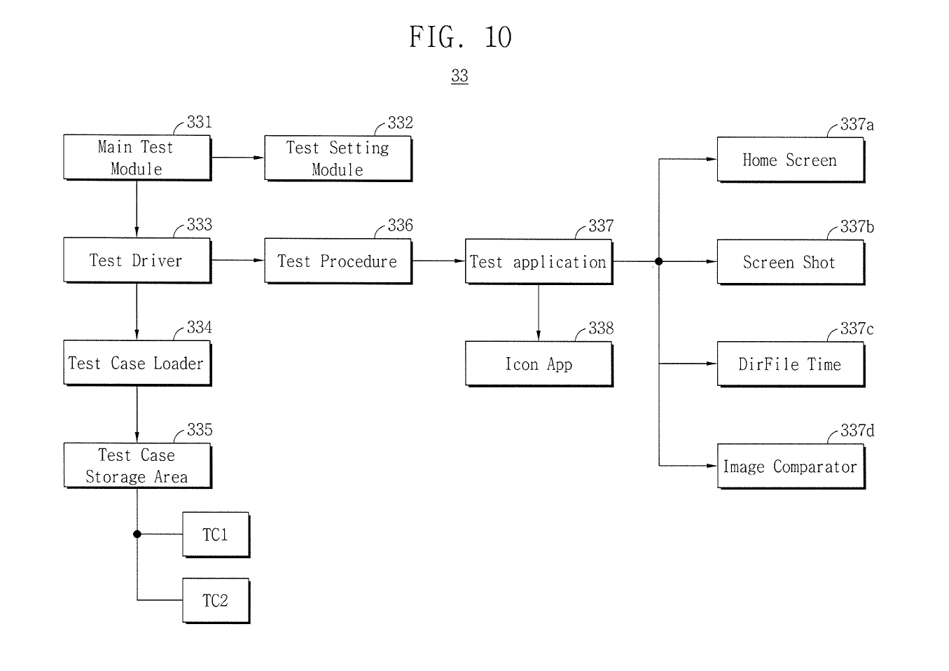

The FCM 33 may include basic test modules for evaluating the mobile device 10. Some of these basic test modules included in the FCM 33 will be described below with reference to FIG. 10. For example, the TAF 30 may include a picture test module 35, a camera test module 36, and a power measurement module 37 that use the basic test modules. The picture test module 35 may use the basic test modules to evaluate an operation of displaying pictures. The camera test module 36 may use the basic test modules to evaluate the operation of a camera. The power measurement module 37 may use the basic test modules to measure power consumption of the mobile device 10. In addition, the user may use the basic test modules to add a user-developed module 38. The user-developed module 38 is a test module developed by the user that can be used with user-defined operations.

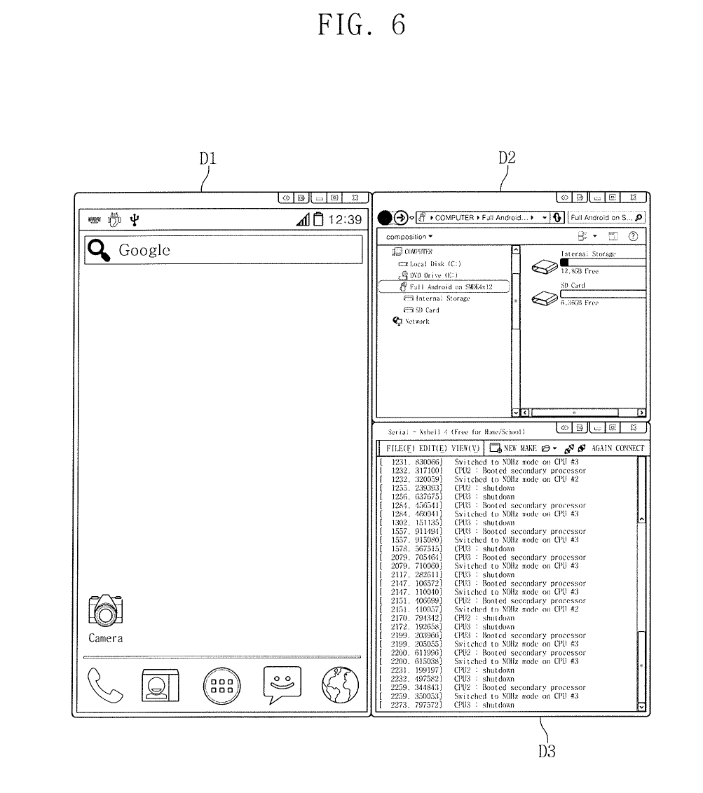

FIG. 6 shows an example of a screen of the host 20 shown in FIG. 1, according to an exemplary embodiment of the present inventive concept.

Referring to FIGS. 1 and 6, a first screen D1 shows an image corresponding to the screen of the mobile device 10, a second screen D2 shows file directories of the mobile device 10 and the host 20, and a third screen D3 shows log files of the TAF 30. Although the example shown in FIG. 1 corresponds to a mobile device 10 running the Android™ operating system, exemplary embodiments are not limited thereto.

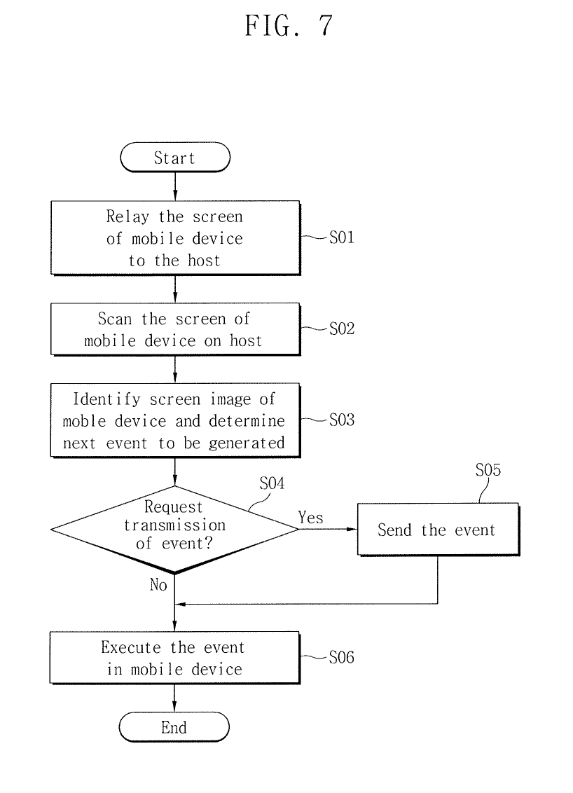

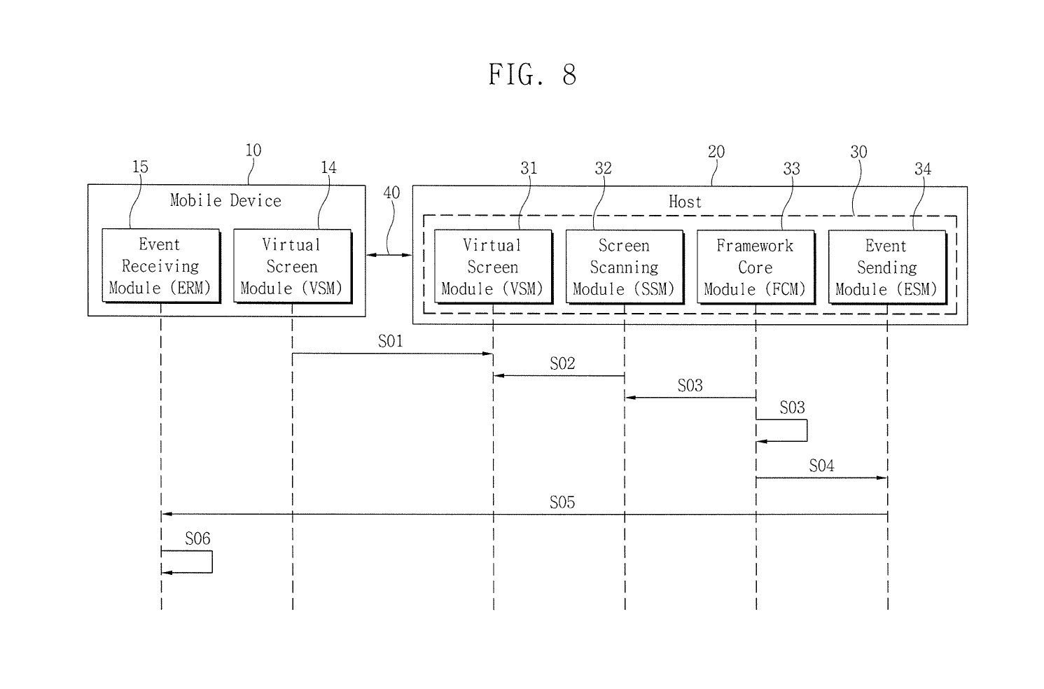

FIG. 7 is a flowchart showing a driving method of the test system 100 shown in FIG. 1, according to an exemplary embodiment of the present inventive concept. FIG. 8 corresponds to FIG. 7, and illustrates the driving operation of the mobile device 10 and the host 20 shown in FIG. 1, according to an exemplary embodiment of the present inventive concept. Although the example described herein corresponds to a mobile device 10 running the Android™ operating system, exemplary embodiments are not limited thereto.

Referring to FIGS. 1, 3, 5, 7 and 8, at block S01, the VSM 14 of the mobile device 10 sends an image corresponding to the screen of the mobile device 10 to the VSM 31 of the host 20 through the ADB 40.

At block S02, the SSM 32 scans the image sent to the host 20 from the mobile device 10. For example, the SSM 32 may compare an image file (e.g., a bitmap) corresponding to the screen image of the mobile device 10 to other image files (e.g., bitmaps) stored at the host 20 respectively corresponding to a plurality of icons, widgets, etc. The SSM 32 may then send the results of the comparison to the FCM 33.

At block S03, the FCM 33 may identify the screen image of the mobile device 10 based on the results of the comparison. For example, the FCM 33 may identify the locations of a plurality of icons and/or a plurality of widgets, and may determine that the screen image of the mobile device 10 corresponds to a GUI (e.g., a home screen) of the mobile device 10.

Further, at block S03, the FCM 33 may determine the next event to be generated. For example, the FCM 33 may send an event corresponding to touching or dragging a specific application icon, an event corresponding to typing on the screen of the mobile device 10, etc., to the mobile device 10.

At block S04, the FCM 33 determines whether to request transmission of the event to the mobile device 10. If it is determined that the event is to be transmitted, the event is sent at block S05. If it is determined that the vent is not to be transmitted, the method progresses to block S06.

For example, if no event is generated at the mobile device 10, or if the mobile device 10 is in an idle state, the FCM 33 may request that the ESM 34 send the event to the mobile device 10.

At block S05, the ESM 34 sends the event to the ERM 15 of the mobile device 10.

At block S06, the ERM 15 of the mobile device 10 receives the event sent from the ESM 34 of the host 20. The ERM 15 then executes the event at the mobile device 10. For example, the ERM 15 may provide an effect corresponding to the event to the screen of the mobile device 10. For example, if the event is to touch an Angry Birds™ icon on the screen of the mobile device 10, the ERM 15 may execute the corresponding Angry Birds™ application on the mobile device 10.

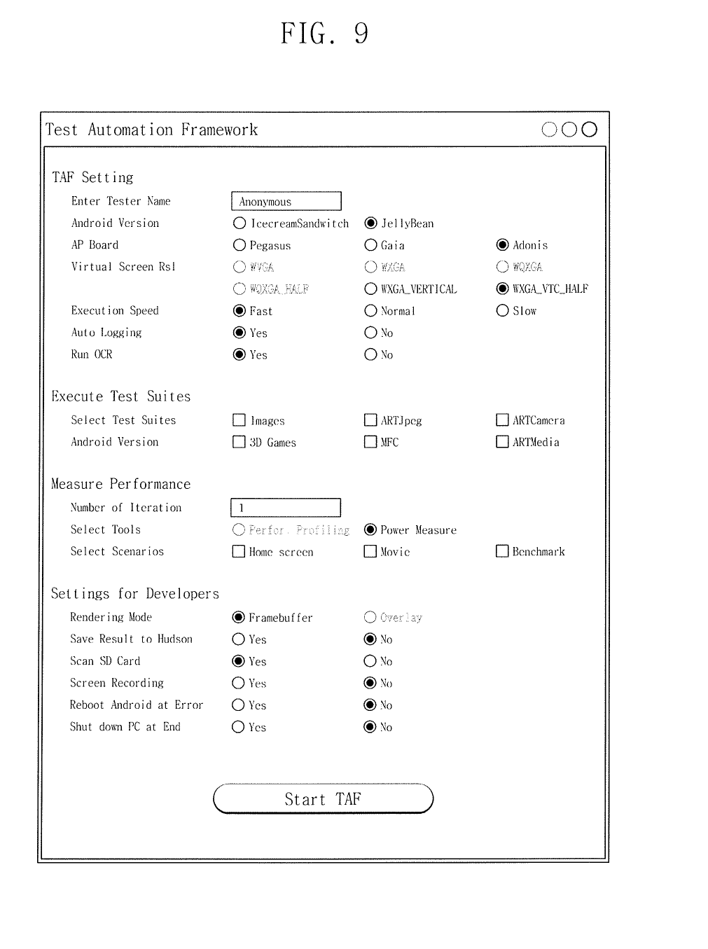

FIG. 9 shows an example of settings of the TAF 30 shown in FIG. 5, according to an exemplary embodiment of the present inventive concept. Although the example shown in FIG. 9 corresponds to a mobile device 10 running the Android™ operating system, exemplary embodiments are not limited thereto.

Referring to FIGS. 1 and 9, the TAF 30 is software that is driven to evaluate the mobile device 10 on the host 20, as described above.

The settings of the TAF 30 vary, and may include, for example, settings for execution of test suites, settings for performance measurement, settings for developers, etc. The basic settings of the TAF 30 may include, for example, entering a test name, selecting an operating system version, selecting the type of AP board, setting the resolution of a virtual screen, setting an execution speed, selecting auto logging, setting whether to run an optical character reader (OCR), etc.

If auto logging is enabled, the TAF 30 may store log files of both the mobile device 10 and the host 20, or log files of either the mobile device 10 or the host 20. If OCR is enabled, the TAF 30 may read text from the image using an OCR application. For example, the TAF 30 may read a benchmark score of the mobile device 10.

The settings for execution of test suites may include the selection of which test suites to execute. For example, a user may select test suites to be performed based on the specific functionality of the mobile device 10 to be tested. For example, the test suites may include test suites respectively configured to test still images, video, a camera, 3D games, etc. That is, the TAF 30 may perform a test of evaluating only still images by selecting an appropriate test suite. Further, the TAF 30 may perform a test of evaluating all of still images, video, a camera, and 3D games, by selecting multiple test suites.

Each test suite may include at least one test case. For example, the test case may include an operation of copying a picture file to an SD card or an operation of installing a benchmark application.

The user may select which test suites to be executed, and may further add a user-developed test suite that is able to be driven on the GUI of the mobile device 10.

In the settings for performance measurement, the user may, for example, select scenarios and tools for measuring the performance of the mobile device 10, and may enter the number of iterations by which evaluation will be repeatedly performed. In order to obtain more accurate measurement values, while measuring the performance of the mobile device 10, the TAF 30 may disconnect the mobile device 10 from the host 20 and then reconnect the mobile device 10 to the host 20. The disconnecting and reconnecting between the mobile device 10 and the host 20 may be performed by software, rather than physically disconnecting and reconnecting the mobile device 10 from the host 20.

The settings for developers may include, for example, selecting a rendering mode, selecting whether to save evaluation results, selecting whether to scan an SD card, selecting screen recording, selecting whether to reboot the operation system upon error generation, and selecting whether to shut down the host 20 upon termination.

If screen recording is enabled, the user may record the entire test procedure using a screen storage application.

If the setting to reboot the operation system upon error generation is selected, the TAF 30 may reboot the mobile device 10, and the TAF 30 may then resume the next test case. For example, the TAF 30 may provide a reboot signal using the JTAG specification to reboot the mobile device 10.

The user of the TAF 30 may create a new test item or add new settings to the settings of the TAF 30 by upgrading the software.

FIG. 10 is a block diagram showing further detail of the FCM 33 shown in FIG. 5, according to an exemplary embodiment of the present inventive concept.

Referring to FIGS. 5 and 10, a main test module 331 may set some or all of test modules. For example, the main test module 331 may set the picture test module 35, the camera test module 36, and the power measurement module 37. For example, the main test module 331 may initialize the TAF 30, cause the display of messages, and control a test setting module 332 for registering hot keys. The main test module 331 may be driven when a test driver 333 is called.

A test case storage area 335 may store at least one test case. For example, the test case storage area 335 may store first and second test cases TC1 and TC2.

The test driver 333 may read the test cases (e.g., the first and second test cases TC1 and TC2) stored in the test case storage area 335 through a test case loader 334.

The test driver 333 may call a test procedure 336 for the first test case TC1. Before driving the first test case TC1, the test procedure 336 may configure a testing environment for the mobile device 10. For example, the test procedure 336 may control an operation of copying a picture file to an SD card, an operation of installing a benchmark application, etc. The test procedure 336 may further call a test application 337.

The test application 337 may perform actual testing for the first test case TC1. The test application 337 may perform various other functions. For example, the test application 337 may fetch a current time, capture a screen shot, store the results of testing in an arbitrary file, etc.

The test application 337 may perform an icon application 338, and may execute a home screen 337a, a screen shot 337b, a directory file time 337c, and an image comparator 337d process through the icon application 338.

The home screen 337a is an application for relaying the current screen of the mobile device 10 to a home screen. The screen shot 337b is an application for capturing the current screen of the mobile device 10. The directory file time 337c is an application for reading information corresponding to the current time of the mobile device 10. The image comparator 337d is an application for comparing images to each other.

After the actual testing of the test application 337 is terminated, in order to execute the second test case TC2, the test procedure 336 may perform a task for terminating testing of the first test case TC1. For example, the test procedure 336 may perform an operation of removing picture files of the first test case TC1, an operation of deleting a benchmarking application, etc.

If an exception occurs while the current test case is being executed, the test driver 333 may restart the test procedure from the beginning.

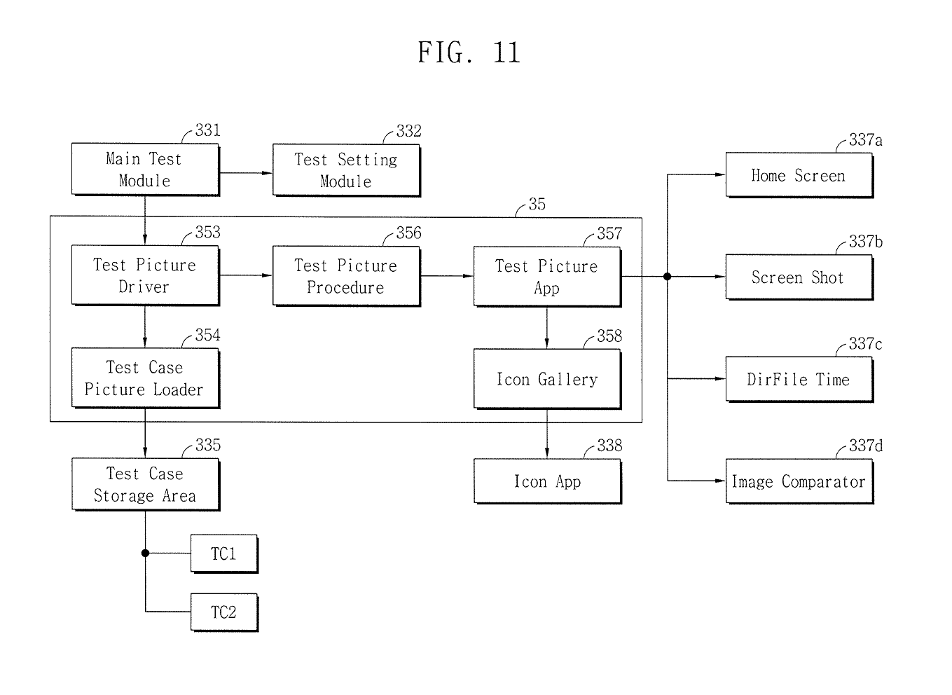

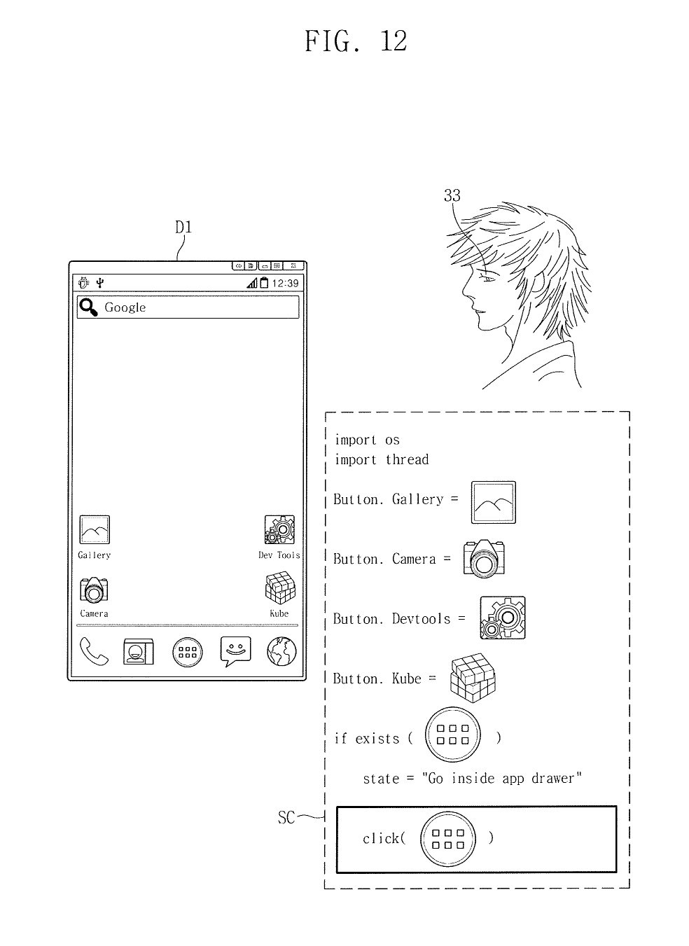

FIG. 11 is a block diagram showing the picture test module 35 shown in FIG. 5, according to an exemplary embodiment of the present disclosure.

Referring to FIGS. 1, 5, 10 and 11, the picture test module 35 may test a function of displaying picture files stored in the mobile device 10. The picture test module 35 may be created using the basic test modules of the FCM 33. The basic test modules may load a test case for evaluating the hardware or software of the mobile device 10, and may drive the test case.

For example, the picture test module 35 may use the main test module 331, the test setting module 332, the test case storage area 335, etc. as the basic test modules.

The picture test module 35 may use a test picture driver 353 extended from the test driver 333 of the FCM 33. For example, the test picture driver 353 may have a function for displaying picture files in addition to the functions of the test driver 333. Accordingly, the test picture driver 353 may use the functions of the test driver 333. Further, the picture test module 35 may use a test picture procedure 356 extended from the test procedure 336 of the FCM 33, a test picture application 357 extended from the test application 337 of the FCM 33 and an icon gallery 358, and a test case picture loader 354 extended from the test case loader 334 of the FCM 33.

The FCM 33 may be extended by test suite modules specified by a user. For example, if a test engineer wants to test a function of displaying picture images stored in the mobile device 10, the test engineer may develop a picture test item by extending the test case loader 334, the test driver 333, the test procedure 336, and the test application 337.

When the TAF 30 is driven, picture test components specified by a test engineer may be executed to evaluate the display function of the mobile device 10.

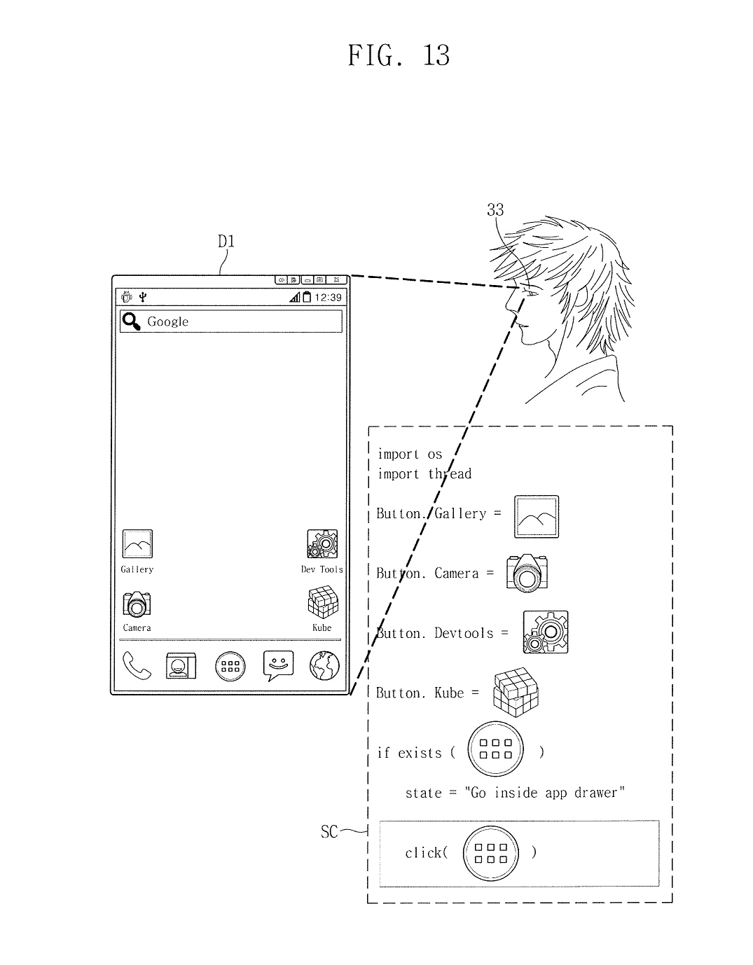

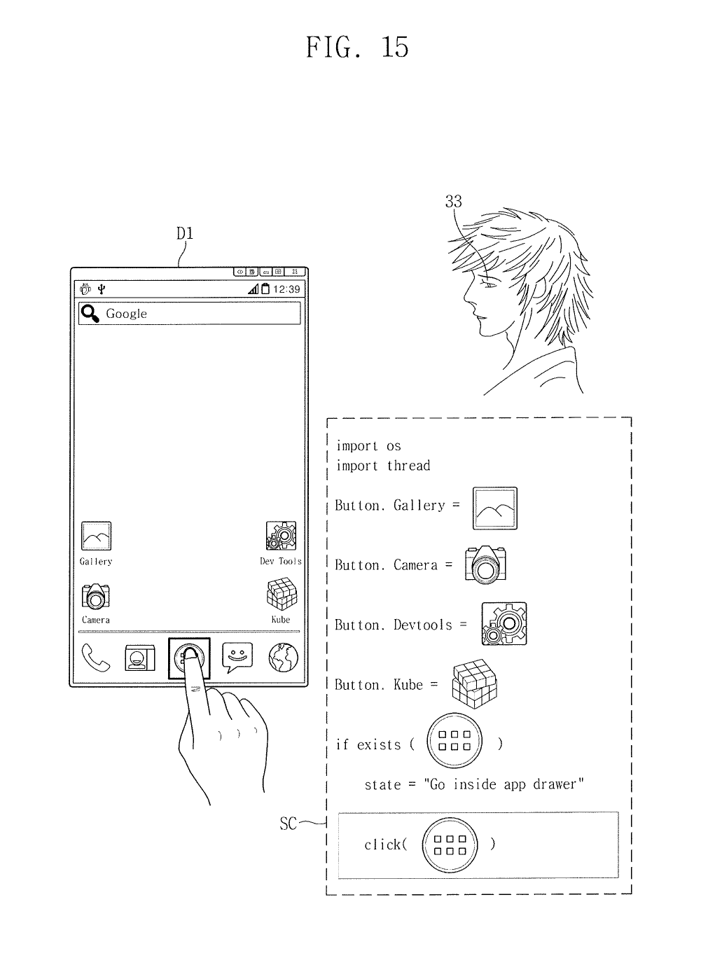

FIGS. 12 through 20 show the screens of the host 20 shown in FIG. 1 and scripts SC for driving the TAF 30 shown in FIG. 1, according to exemplary embodiments of the present inventive concept.

Referring to FIGS. 1, 5 and 12, an image corresponding to the screen of the mobile device 10 is displayed on a first screen D1 of the host 20. The viewpoint of a user, as shown in FIGS. 12 to 20, may correspond to the FCM 33 that identifies the screen of the host 20. For example, similar to a user viewing the screen, the TAF 30 may scan the screen of the host 20, and identify the screen of the host 20 according to the results of the scanning.

The scripts SC may include image files (e.g., bitmaps) corresponding to icons, such as, for example, a gallery application, a camera application, device tools, etc.

The scripts SC further show an operation that is to be executed next. For example, an area surrounded by dotted lines in FIG. 12 shows a script to be executed next. In the current example, the script to be executed next indicates execution of an application drawer called “Appdrawer.” If the application drawer is executed, an application screen may be displayed on the screen of the mobile device 10. The application screen is a screen showing a list of applications. A plurality of application icons may be arranged on the application screen.

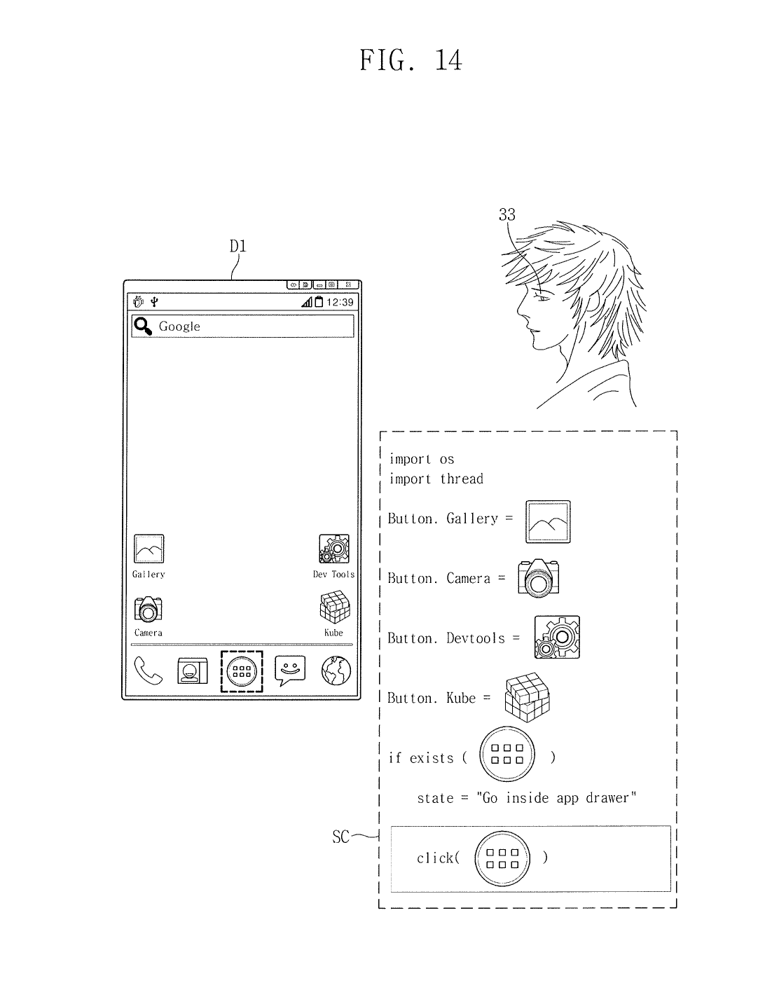

Referring to FIGS. 1, 5, and 13, on the first screen D1, the screen of the host 20 is displayed. The FCM 33 may identify the screen of the host 20. Accordingly, the FCM 33 may identify the location of an icon to be executed next. That is, in FIG. 13, the FCM 33 may identify the location of the application drawer, which is the icon to be executed next.

For example, the current screen of the host 20 may be displayed on the first screen D1. The SSM 32 may scan the screen of the host 20. That is, the SSM 32 may compare an image file (e.g., a bitmap) corresponding to the screen of the host 20 to an image file (e.g., a bitmap) corresponding to the application drawer in the scripts SC, and then send the results of the comparison to the FCM 33. Accordingly, the FCM 33 may identify the location of the application drawer based on the results of the comparison.

Referring to FIGS. 1, 5, and 14, on the first screen D1, an icon of the application drawer is selected. Accordingly, the TAF 30 may test the application drawer.

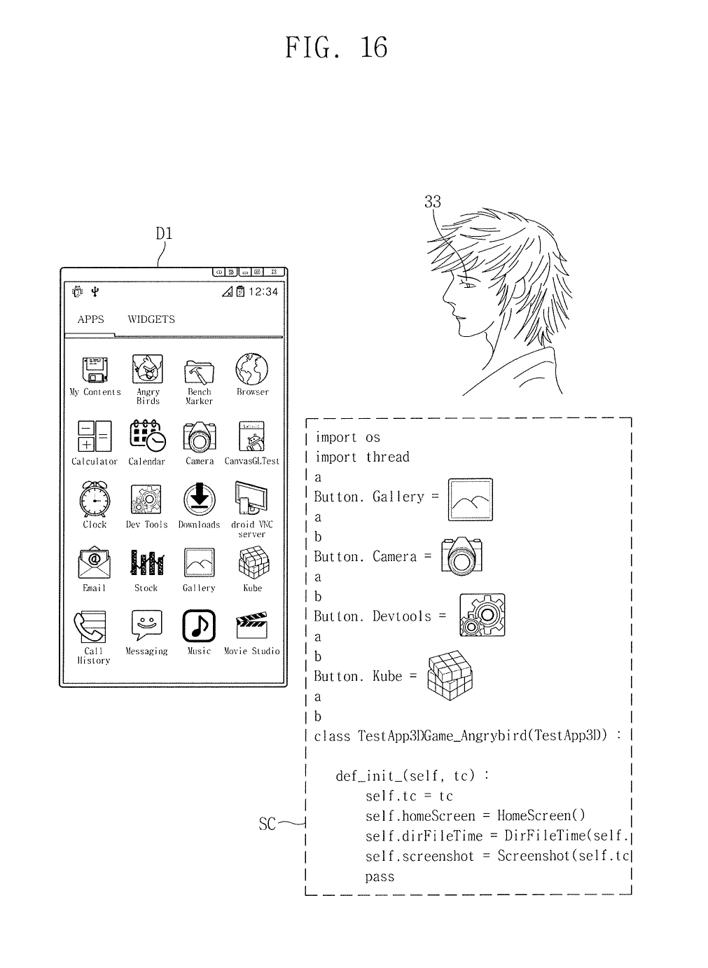

Referring to FIGS. 8 and 15, on the first screen D1, an operation corresponding to clicking the icon of the application drawer is shown. Accordingly, the TAF 30 may execute an event corresponding to clicking the icon of the application drawer.

For example, the FCM 33 may request the ESM 34 to send an event corresponding to clicking the icon of the application drawer to the mobile device 10. That is, the ESM 34 may send an event corresponding to clicking the icon of the application drawer to the ERM 15. Accordingly, the ERM 15 may receive the event corresponding to clicking the icon of the application drawer, and execute the event at the mobile device 10.

Referring to FIG. 16, on the first screen D1, a screen appearing after the application drawer is executed is shown. In the current example, an Angry Birds™ application icon is displayed on the screen.

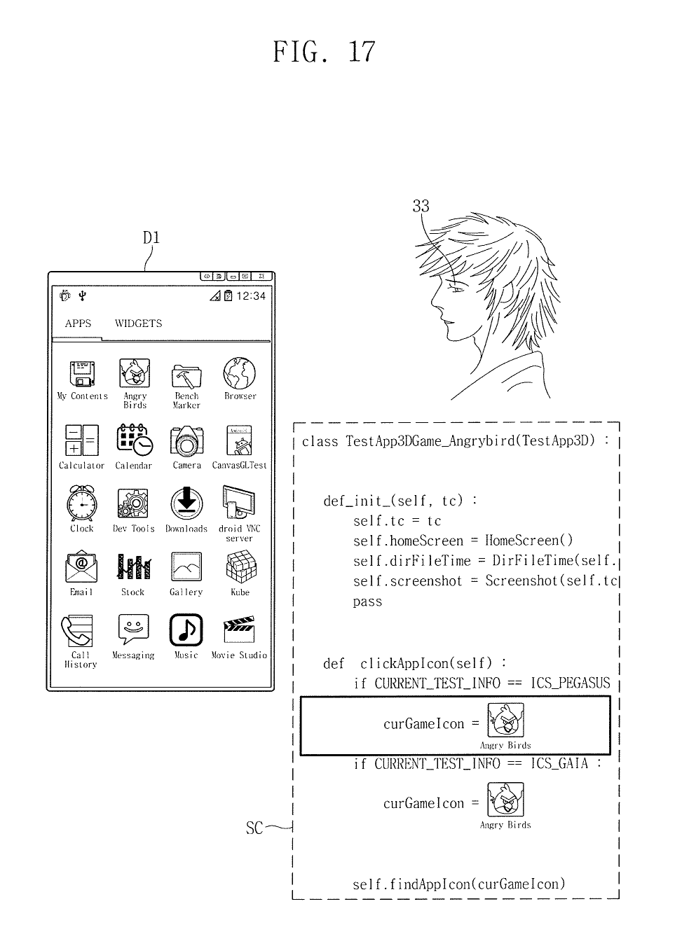

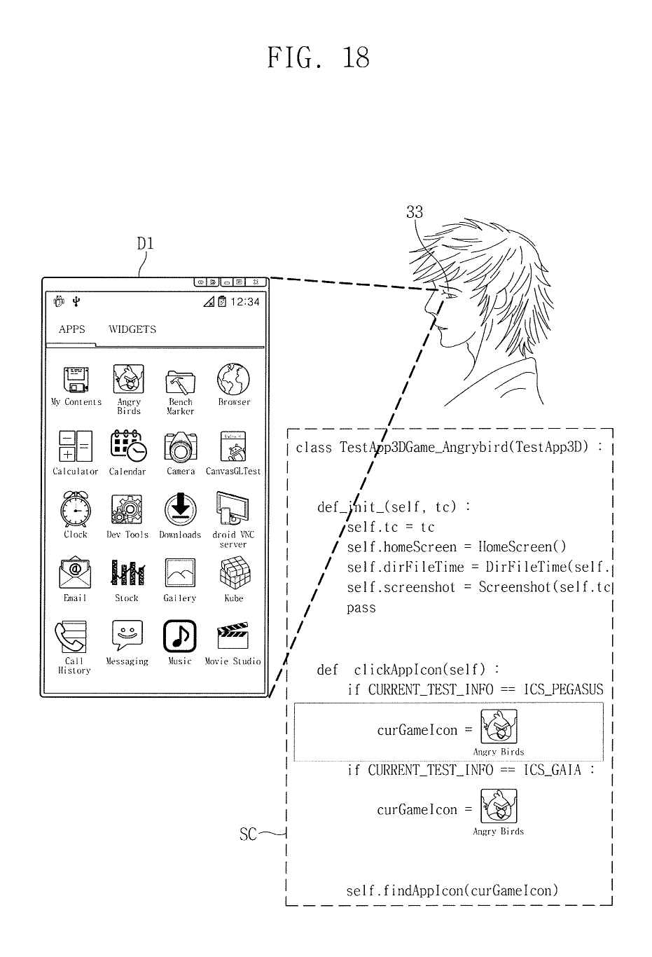

Referring to FIG. 17, on the first screen D1, a plurality of applications, including the Angry Birds™ application icon, are shown. The scripts SC include an icon to be executed next. In the current example, the icon to be executed next is the Angry Birds™ application icon.

Referring to FIGS. 8 and 18, on the first screen D1, a screen appearing after the application drawer is executed is shown. The SSM 32 may scan the screen of the host 20. For example, the SSM 32 may compare an image file (e.g., a bitmap) corresponding to the screen of the host 20 to an image file (e.g., a bitmap) corresponding to the Angry Birds™ application of the scripts SC. Then, the SSM 32 may send the results of the comparison to the FCM 33. The FCM 33 may identify the location of the Angry Birds™ application based on the results of the comparison.

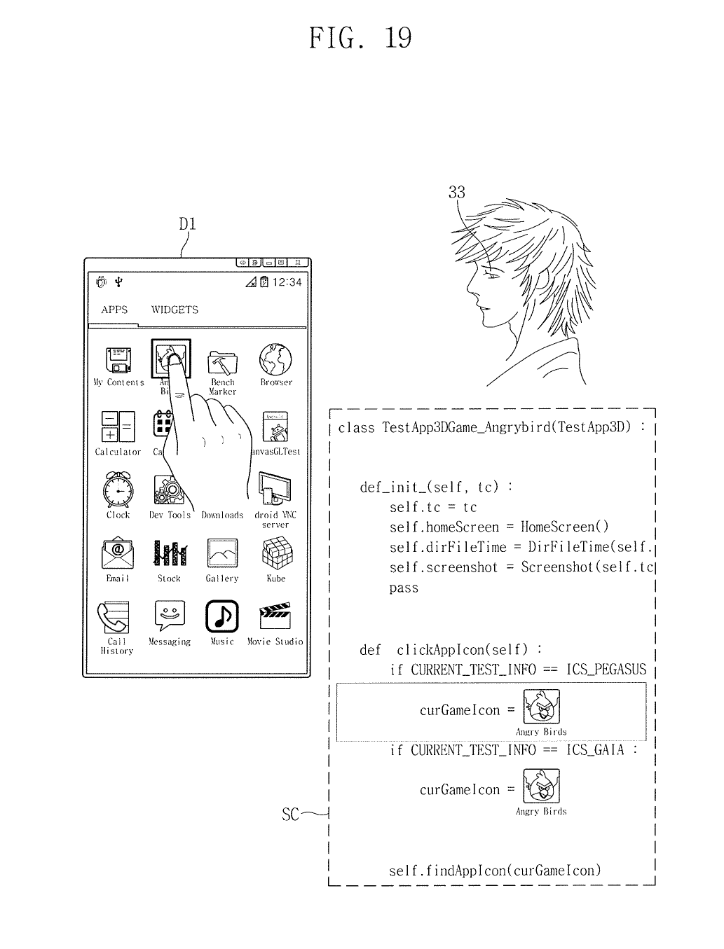

Referring to FIGS. 8 and 19, on the first screen D1, an operation corresponding to clicking the icon of the Angry Birds™ application is shown. That is, the TAF 30 may execute an event corresponding to clicking the icon of the Angry Birds™ application.

For example, the FCM 33 may request the ESM 34 to send an event corresponding to clicking the icon of the Angry Birds™ application to the mobile device 10. That is, the ESM 34 may send the event corresponding to clicking the icon of the Angry Birds™ application to the ERM 15. Accordingly, the ERM 15 may receive the event corresponding to clicking the icon of the Angry Birds™ application, and execute the event.

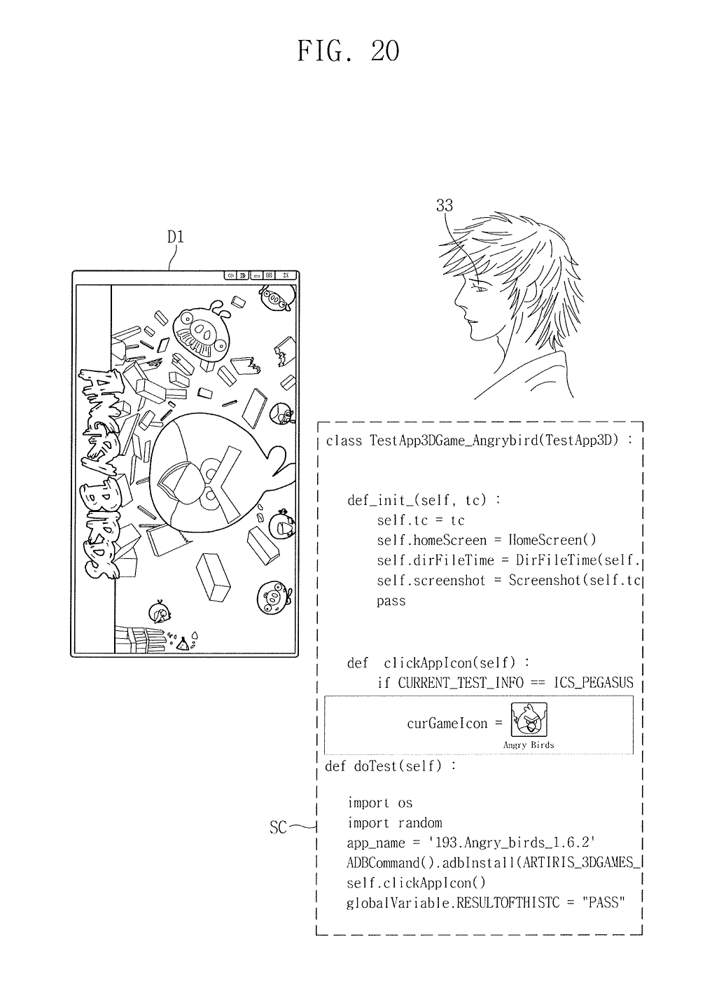

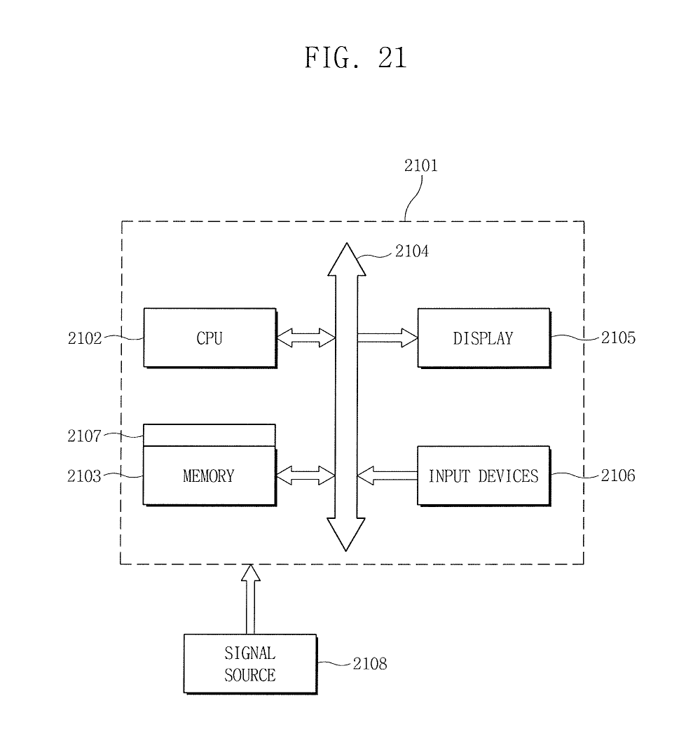

Referring to FIG. 20, on the first screen D1, a screen appearing when the Angry Birds™ application is executed is displayed.

It is to be understood that the present inventive concept may be implemented in various forms of hardware, software, firmware, special purpose processors, or a combination thereof. That is, exemplary embodiments of the present inventive concept may be embodied directly in hardware, in a software module(s) executed by a processor, or in a combination of the two. In one embodiment, the present inventive concept may be implemented in software as an application program tangibly embodied on a non-transitory program storage device. The application program may be uploaded to, and executed by, a machine comprising any suitable architecture.

Referring to FIG. 21, according to an embodiment of the present inventive concept, a computer system 2101 supporting a test system for evaluating a mobile device and a driving method thereof includes, inter alia, a central processing unit (CPU) 2102, a memory 2103 and an input/output (I/O) interface 2104. The computer system 2101 is generally coupled through the I/O interface 2104 to a display 2105 and various input devices 2106 such as a mouse and keyboard. The support circuits can include circuits such as cache, power supplies, clock circuits, and a communications bus. The memory 2103 can include random access memory (RAM), read only memory (ROM), disk drive, tape drive, or a combination thereof. Exemplary embodiments of the present invention can be implemented as a routine 2107 that is stored in memory 2103 and executed by the CPU 2102 to process the signal from the signal source 2108. As such, the computer system 2101 is a general-purpose computer system that becomes a specific-purpose computer system when executing the routine 2107 of the present inventive concept.

It is to be further understood that, because some of the constituent system components and methods depicted in the accompanying figures may be implemented in software, the actual connections between the system components (or the processes) may differ depending upon the manner in which the present inventive concept is programmed. Given the teachings of the present inventive concept provided herein, one of ordinary skill in the related art will be able to contemplate these and similar implementations or configurations of the present inventive concept.

While the present inventive concept has been particularly shown and described with reference to the exemplary embodiments thereof, it will be understood by those of ordinary skill in the art that various changes in form and detail may be made therein without departing from the spirit and scope of the present inventive concept as defined by the following claims.

What is claimed is:

1. A test system, comprising:
a mobile device comprising an evaluation application; and
a host comprising a test automation framework (TAF),
wherein the host is configured to receive an image corresponding to a screen of the mobile device via the evaluation application and the TAF, display the received image on a screen of the host, scan the received image, and identify a portion of the received image based on a result of scanning the received image.

2. The test system according to claim 1, wherein the TAF is configured to send an event corresponding to an actual operation to be performed on the mobile device to the evaluation application.

3. The test system according to claim 1, wherein the image comprises at least one application icon or at least one application widget.

4. The test system according to claim 3, wherein the TAF is configured to compare an image file corresponding to the received image to a plurality of image files corresponding to a plurality of stored icons stored at the host or a plurality of stored widgets stored at the host.

5. The test system according to claim 4, wherein the TAF is configured to identify the portion of the received image based on a result of the comparison.

6. The test system according to claim 1, wherein the mobile device is configured to connect to the host through an android debug bridge (ADB) that utilizes a Universal Serial Bus On-The-Go (USB OTG) specification.

7. The test system according to claim 1, wherein the TAF comprises:
a virtual screen module (VSM) configured to receive the image corresponding to the screen of the mobile device from the evaluation application, and display the received image on the screen of the host;
a screen scanning module (SSM) configured to scan the received image; and
a framework core module (FCM) configured to identify the portion of the received image based on the result of scanning the received image,
wherein the FCM comprises a basic test module for evaluating the mobile device, and the basic test module is configured to load a test case for evaluating hardware or software of the mobile device and drive the test case.

8. The test system according to claim 7, wherein the TAF further comprises a user-developed test module configured to use the basic test module.

9. The test system according to claim 7, wherein the TAF further comprises:
a picture test module (PTM) configured to evaluate an operation of displaying pictures using the basic test module;
a camera test module (CTM) configured to evaluate an operation of a camera of the mobile device using the basic test module; and
a power measurement module (PMM) configured to measure power consumption using the basic test module.

10. The test system according to claim 1, wherein the mobile device is a smartphone, a tablet computer, or a digital camera driven by an Android™ Operating System (OS).

11. A driving method of a test system, comprising:
receiving an image corresponding to a screen of a mobile device at a host;
displaying the received image on a screen of the host;
scanning the received image displayed on the screen of the host; and
identifying a portion of the received image based on a result of scanning the received image.

12. The driving method according to claim 11, further comprising sending an event corresponding to an actual operation to be performed on the mobile device from the host to the mobile device upon determining that an effect corresponding to the event has not been generated at the mobile device.

13. The driving method according to claim 12, further comprising executing the event sent from the host to the mobile device at the mobile device by the mobile device.

14. The driving method according to claim 11, wherein scanning the received image comprises comparing an image file corresponding to the received image to a plurality of image files corresponding to a plurality of application stored icons stored at the host or a plurality of stored application widgets stored at the host.

15. The driving method according to claim 14, wherein identifying a portion of the received image comprises identifying respective locations of the plurality of icons or the plurality of widgets.

16. A test system, comprising:
a test automation framework (TAF) stored at a host, comprising:
a virtual screen module (VSM) configured to receive an image corresponding to a screen of a mobile device from an evaluation application stored at the mobile device, and display the received image at the host;
a screen scanning module (SSM) configured to scan the received image; and
a framework core module (FCM) configured to identify a portion of the received image based on a result of scanning the received image.

17. The test system according to claim 16, wherein the TAF is configured to send an event corresponding to an actual operation to be performed on the mobile device to the mobile device.

18. The test system according to claim 16, wherein the TAF is configured to compare an image file corresponding to the received image to a plurality of image files corresponding to a plurality of stored icons stored at the host or a plurality of stored widgets stored at the host.

19. The test system according to claim 18, wherein the TAF is configured to identify a portion of the received image based on a result of the comparison.

20. The test system according to claim 16, wherein the FCM comprises a basic test module for evaluating the mobile device, and the basic test module is configured to load a test case for evaluating hardware or software of the mobile device.
